(19) United States
(12) Patent Application Publication
(10) Pub. No.: US 2012/0200875 A1
(43) Pub. Date: Aug. 9, 2012

(54) Pattern Based Scan Batch Separation

(75) Inventor: Marianne Kodimer, Huntington Beach, CA (US)

(73) Assignees: Toshiba Tec Kabushiki Kaisha, Shinagawa-ku (JP); Kabushiki Kaisha Toshiba, Minato-ku (JP)

(21) Appl. No.: 13/308,306

(22) Filed: Nov. 30, 2011

Related U.S. Application Data
(60) Provisional application No. 61/440,300, filed on Feb. 7, 2011.

(51) Int. Cl. G06K 15/02

(52) U.S. Cl. 358/1.13

(57) ABSTRACT

Pattern based scan batch separation is disclosed. A method includes receiving from a user specification of a pattern in a document set, sensing pages, scanning the pages, applying the pattern specification to the pages to create a group of documents, the group of documents including a plurality of documents separated according to the pattern specification. A group of documents is stored in a destination location. The method may be implemented as instructions such as software or firmware and may be performed by a multifunction peripheral (MFP).

### RELATED APPLICATION INFORMATION

This patent claims priority from U.S. Provisional Patent Application No. 61/440,300 entitled “Pattern Based Scan Batch Separation” filed Feb. 7, 2011.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to multifunction peripheral document scanning.

2. Description of the Related Art

A multifunction peripheral (MFP) is a type of document processing device which is an integrated device providing at least two document processing functions, such as print, copy, scan and fax. Pertinent here are MFP devices that provide functionality to scan documents. A document processing request is a request to an MFP to perform at least one document processing function.

Documents may be physically and/or logically divided into pages. A physical document is paper or other physical media bearing information which is readable unaided by the typical human eye. An electronic document is any electronic media form of a physical document, for example a PDF, JPG or TIF file or group of files. When a physical document is scanned, the result is an electronic document. The disclosure herein involves the processing of physical documents into electronic documents. MFP devices provide functionality to scan physical documents directly to electronic document repositories for storage. Specifically, MFP workflow software allows users to scan physical documents and send them as electronic documents to folders on storage in the MFP, folders on network devices, as well as external document management repositories.

Businesses may have document storage space restrictions and/or specific document workflows that benefit from an automatic batch separation feature. Currently, workflow software provides a feature known as “automatic batch separation based on a fixed number of pages.” This feature is useful for workflows that have documents of a fixed number of pages that are processed in large volumes. For example, a bank may receive a plurality of loan applications that must be scanned and stored into a document repository. If, for example, each loan application consists of 10 pages, and the bank accumulates 1,000 loan applications, the ability to scan and store this large stack is made more efficient with an automatic batch separation feature. With automatic batch separation set to a fixed number of 10 (the number of pages of each loan application), the stack could be scanned and automatically separated into separate files every 10 pages. This workflow is addressed by scan workflow software having the “automatic batch separation based on a fixed number of pages” feature.

There is also the case where a document workflow consists of processing not just one document but a set of documents for each customer, client, or patient. Refinance documents, new patient doctor forms, and job applications, may consist of forms where each form across sets is a fixed number, but each form within the set varies in length.

Current batch separation methods based on a fixed number are useful for workflows with fixed page length documents that are stacked and then processed by designated personnel. These methods are not flexible enough to automatically process large volumes of documents having varying page lengths (or page ranges) that are in a set of documents.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a flow chart of a method of receiving user specification of pattern based scan batch separation.

FIG. 6 is an example user interface to receive user specification of pattern based scan batch separation.

FIG. 7 is a flow chart of a method of pattern based scan batch separation.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Described herein is an automatic batch separation feature for a workflow based on a set of documents having a variable page length, the documents appearing in a fixed pattern. A method of batch separation based on a specified page pattern that allows an administrator to configure the scan pattern is described herein.

Apparatus

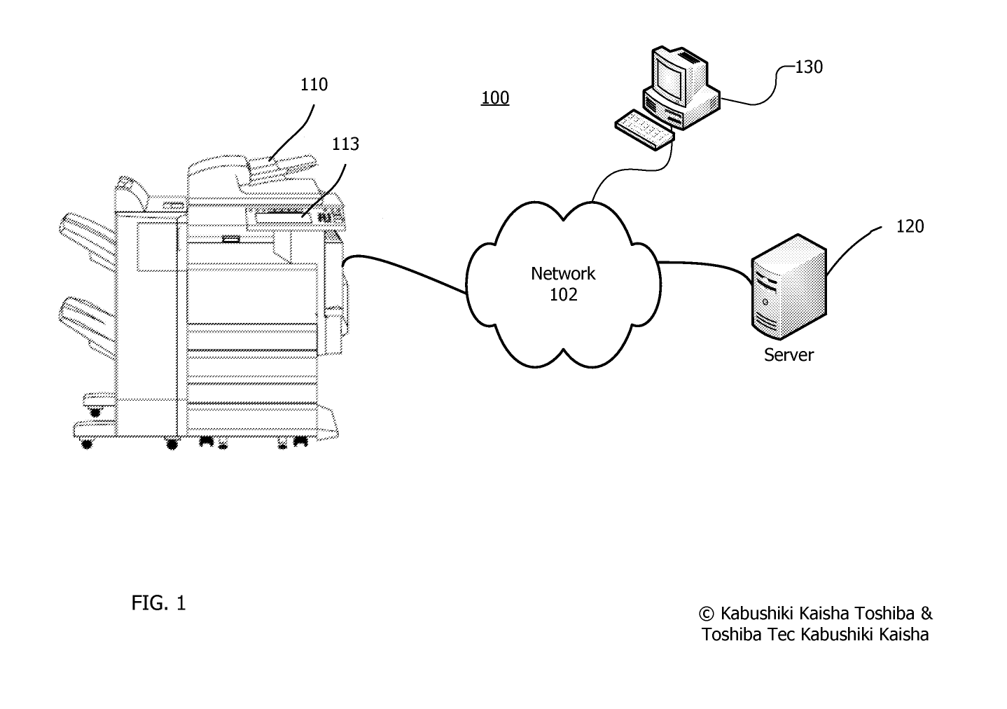

Referring now to FIG. 1 there is shown an MFP system 100. The system 100 includes an MFP 110, a server 120, and a client computer 130, all interconnected by a network 102. The system 100 may be implemented in a distributed computing environment and interconnected by the network 102.

The network 102 may be a local area network, a wide area network, a personal area network, the Internet, an intranet, or any combination of these. The network 102 may be wired or wireless or a combination thereof. The network 102 may have physical layers and transport layers according to IEEE 802.11, Ethernet or other wireless or wire-based communication standards and protocols such as WIMAX®, BLUETOOTH®, the public switched telephone network (PSTN), a proprietary communications network, infrared, and optical.

The MFP 110 may be equipped to receive portable storage media such as USB drives. The MFP 110 includes a user interface subsystem 113 which communicates information to and receives selections from users. The user interface subsystem 113 has a user output device for displaying graphical elements, text data or images to a user and a use input device for receiving user inputs. The user interface subsystem 113 may include a touchscreen, LCD display, touch-panel, alpha-numeric keypad or combination thereof, and/or may include or be an associated thin client or other computing device through which a user may interact directly with the MFP 110.

The server 120 is software operating on a server computer connected to the network. The client computer 130 may be a PC, thin client or other device. The client computer 130 is representative of one or more end-user devices and may be considered separate from the system 100.

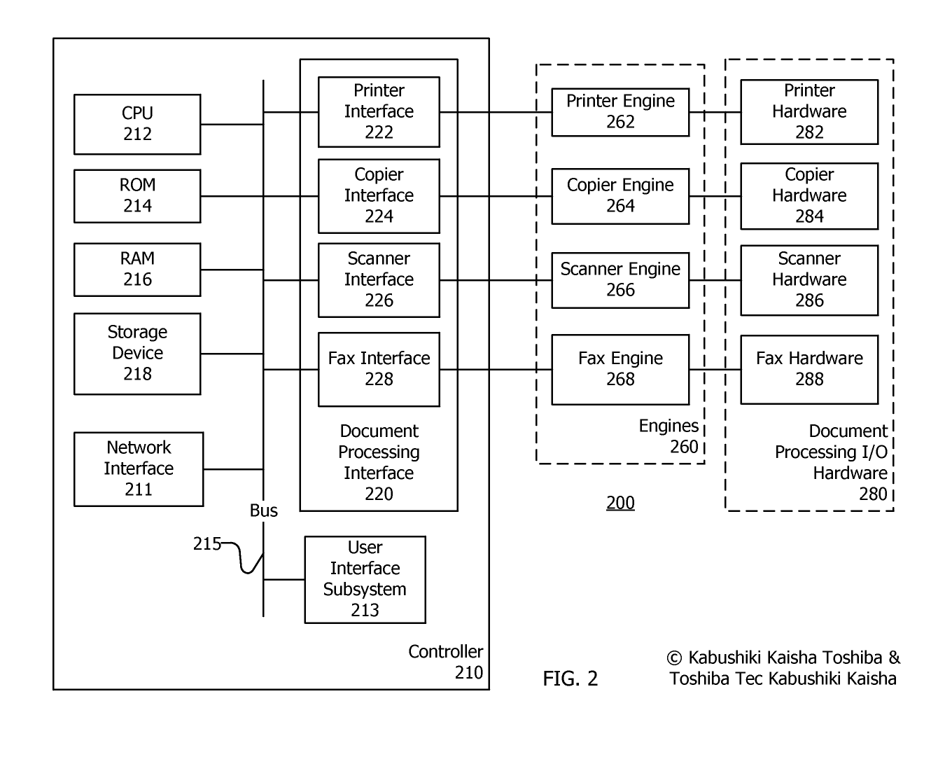

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage device 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server, thin client or other computing device associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage device 218 provides volatile, bulk or long term storage of data associated with the MFP 200, and may be or include magnetic disk, optical disk, magnetic tape or solid state storage. The three storage components, ROM 214, RAM 216 and storage device 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the IDE, EIDE, PCI, PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be implemented as software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete document processing functions.

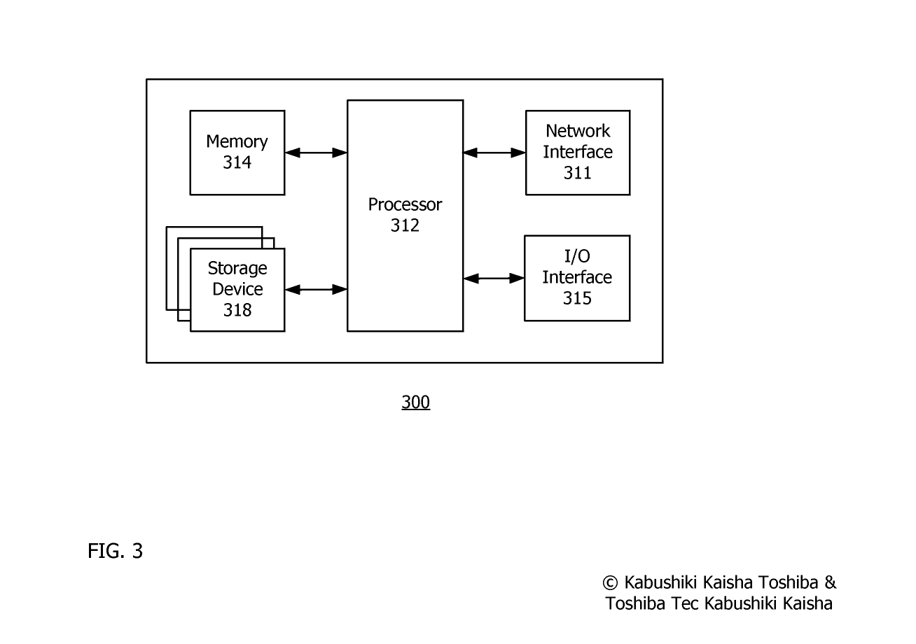

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 and other computing devices mentioned herein may include one or more of logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage device 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage device 318 provides nonvolatile, bulk or long term storage of data or instructions in the computing device 300. The storage device 318 may be a reader and/or writer for and may include a magnetic disk, magnetic tape, optical disks such as, for example, CD, DVD and Blu-Ray Disks, or other reasonably high capacity addressable or serial storage medium. (As used herein, the term storage medium does not include transitory media such as signals or waveforms.) Multiple storage devices may be provided or available to the computing device 300. Some of these storage devices may be external to the computing device 300, such as network storage or cloud-based storage.

The network interface 311 includes an interface to a network such as network 102 (FIG. 1).

The I/O interface 315 interfaces the processor 312 to peripherals (not shown) such as displays, keyboards and USB devices.

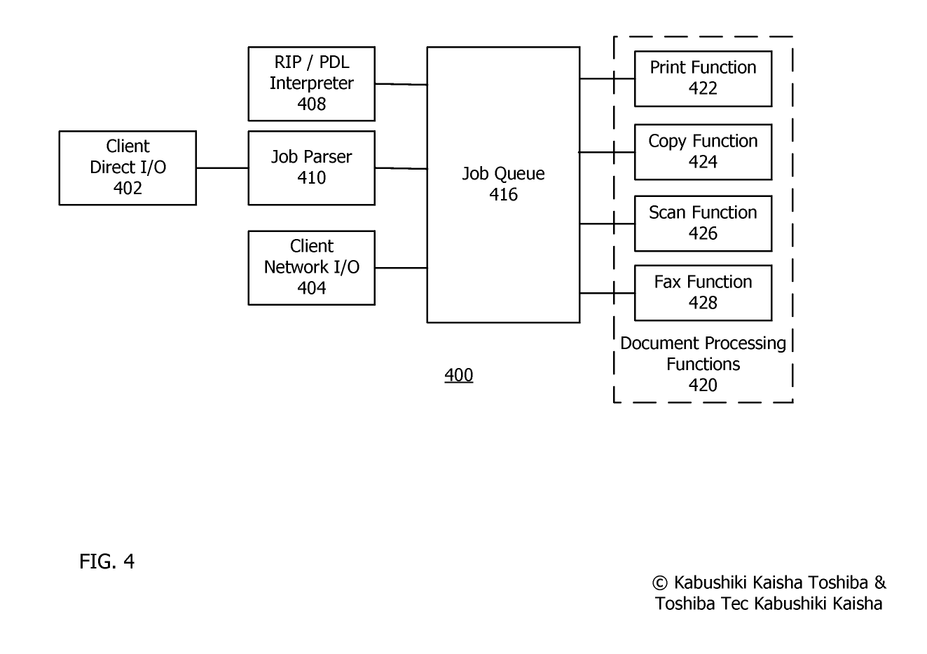

Turning now to FIG. 4 there is shown a block diagram of a software system 400 of an MFP which may operate on the controller 210 (FIG. 2). The system 400 includes client direct I/O unit 402, client network I/O unit 404, a RIP/PDL interpreter 408, a job parser 410, a job queue 416, a series of document processing functions 420 including a print function 422, a copy function 424, a scan function 426 and a fax function 428.

The client direct I/O 402 unit and the client network I/O unit 404 provide input and output to the MFP controller. The client direct I/O 402 provides for communication through the user interface on the MFP (e.g., user interface subsystem 113), and the client network I/O 404 provides for communication through user interfaces over the network. The input and output communications may include documents for printing or faxing or parameters for MFP functions. In addition, the input and output communications may include commands to control operations of the MFP. The network-based access via the client network I/O unit 404 may be accomplished using HTTP, TCP, FTP, UDP, electronic mail TELNET or other network communication protocols.

The RIP/PDL interpreter 408 transforms PDL-encoded documents received by the MFP into raster images or other forms suitable for use in MFP functions and suitable for output by the MFP. The RIP/PDL interpreter 408 processes documents and adds the resulting output to the job queue 416 to be output by the MFP.

The job parser 410 interprets received documents and relays them to the job queue 416 for handling by the MFP. The job parser 410 may perform functions including interpreting data received to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O unit 402 or the client network I/O unit 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O unit 402. The client direct I/O unit 402 may include printing, fax transmission or other input of a document for handling by the system 400.

The print function 422 enables the MFP to print documents and implements the various functions related to that process. These functions include stapling, collating, hole punching, and similar functions. The copy function 424 enables the MFP to perform copy operations and all related functions such as multiple copies, collating, two to one page copying or one to two page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer, thin client, or other computing device. The user interface for some or all document processing functions may be provided locally by the MFP's user interface subsystem though the document processing function is executed by a computing device separate from but associated with the MFP.

Methods

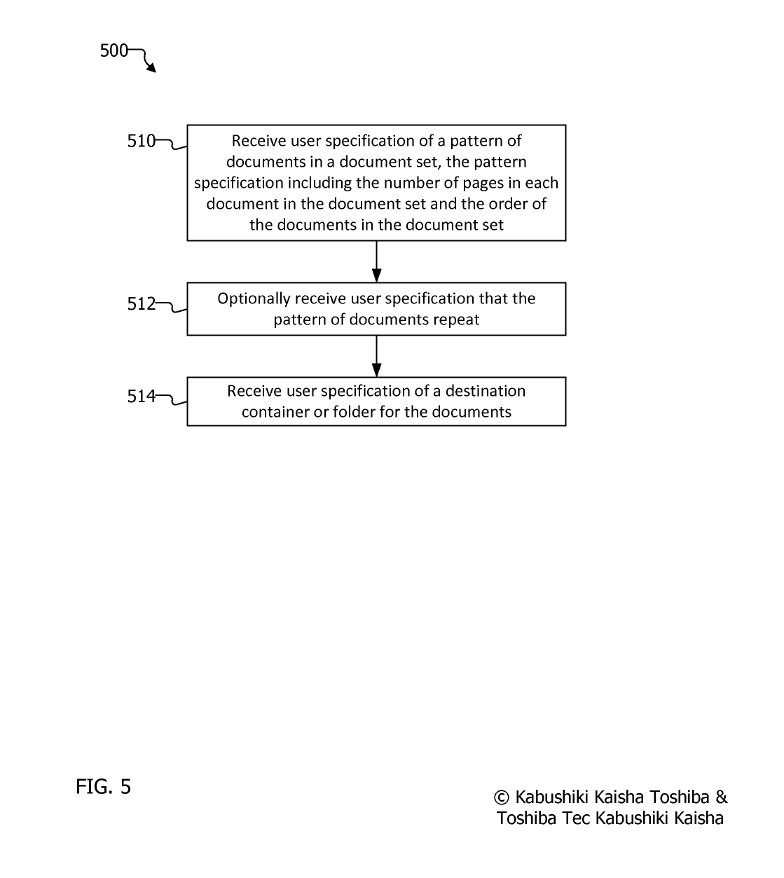

FIG. 5 is a flow chart 500 of a method of receiving user specification of pattern based scan batch separation. The specification of a pattern of documents in a document set is received from a user, the pattern specification includes the number of pages in each document in the document set and the order of the documents in the document set, as shown in block 510. Whether the pattern is repeated is received from a user, as shown in block 512. That is, a user may specify a group of documents that are included in a set, that group (or pattern) being repeated. A user specification of a destination container or folder for each of the documents may be received from the user, as shown in block 514. The folder or container may be specified on a per document, per set and/or per batch basis.

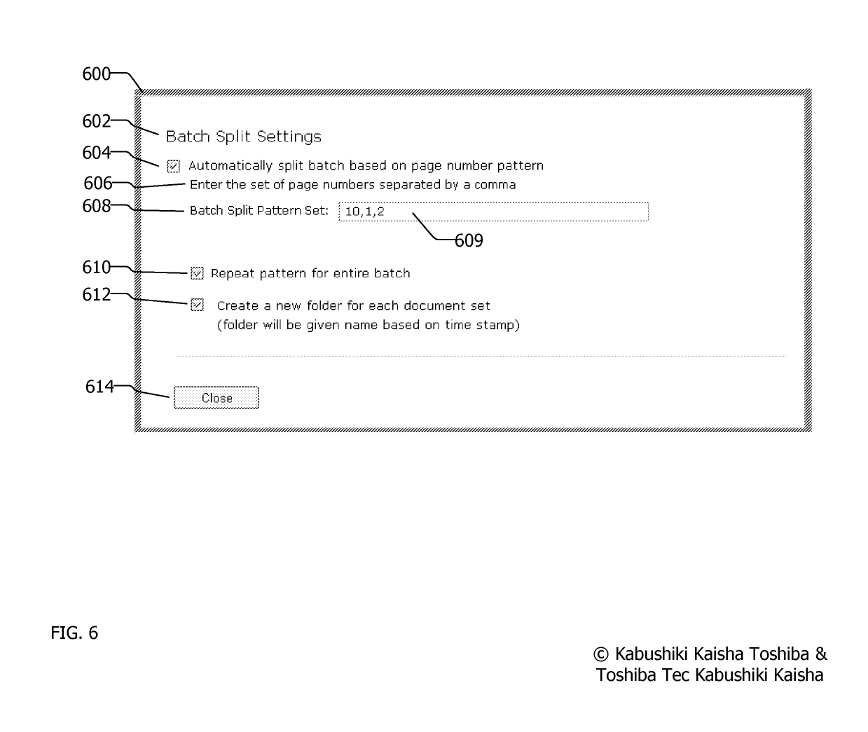

An example user interface 600 provided on the display 113 of the MFP or client computing device 130 to receive user specification of pattern based scan batch separation is shown in FIG. 6. The MFP administrator (or user) selects to use automatic batch split scan settings and is provided the user interface 600 which informs the user by a text label 602 that “Batch Split Settings” may be entered.

The user interface provides the user the option to automatically split the batch based on a page number pattern by providing descriptive text and a user interface item that allows for selection, such as, for example, a check box, radio button, of other user interface item. As shown in FIG. 6, this option may be chosen by a user selecting check box 604. When box 604 is checked, the user interface may provide prompting such as instructive text 606 asking the user to enter the set of page counts for the pattern. The pattern may be specified in the UI as a string of numbers delineated. For example, a space, or comma or other punctuation may be provided in a text entry box 609 by the “batch split pattern set” text label 608. The total number of numbers entered is used to calculate a “batch split pattern total.” This may also be thought of as the number of items in the string in box 609. The page total is the sum of the number for each position in the batch split pattern. The page total corresponds to the number of scanned pages that may constitute the split for saving documents in folders by sets.

In the example shown in FIG. 6, the batch split pattern total is 3, meaning there are three page counts specified, namely “10, 1, 2”. As such, three documents, one each having page counts of 10 pages, 1 page and 2 pages will be stored as a set. In this example, sets or groups of three documents having page counts of 10, 1 and 2 may be scanned and stored. Specifically, as the first page count is 10, after scanning 10 pages of the stack, a first document will be created. As the second page count is one, after scanning one additional page, a second document will be created. As the third page count is two; after scanning two additional pages, a third document will be created.

The UI allows the user to specify that the pattern will be repeated through the entire batch by a check box 610 (or other user interface item) and associated text. When the “Repeat pattern for entire batch” is checked, the pattern will repeat for the remainder of the input stack or batch. If the checkbox were unchecked, the pattern would complete once, and any remaining pages in the stack would comprise a different, additional single document.

The UI allows the user to specify to create a new folder for each document set scanned by selecting check box 612 (or other similar action on another user interface item) for which associated text is provided. In other implementations each document may be included in a single folder or related documents may be grouped by pattern or kind. When the “Create a new folder for each document set” check box 612 is checked, each document set is written to a folder (or subfolder of a specified or default location) that is created on the fly. In the example shown in FIG. 6, for every folder created, three documents will be placed in each. If this checkbox were unchecked, all documents would be written to a default destination or a destination specified elsewhere in a workflow.

In other embodiments, additional user interface fields may be provided that allow the user to specify file names for each set and/or for each of the files in the set. The specification may be text, system provided values such as date and time, and the like. Similarly, the user may be able to designate folders in which each portion of a set or each set is stored.

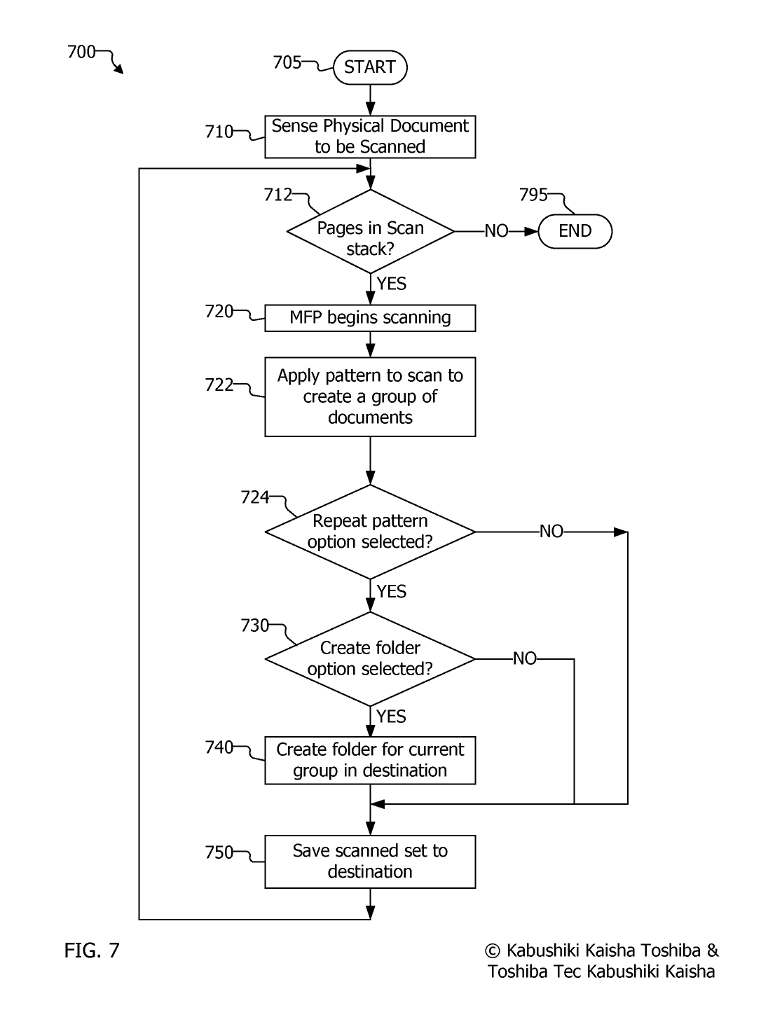

FIG. 7 is a flow chart 700 of a method of pattern based scan batch separation. The method begins at start 705. A group of documents or batch is placed in the MFP by a user and the MFP senses the physical document to be scanned, as shown in block 710. A check is made to confirm there are pages in the scan stack, as shown in block 712. When there are no pages in the scan stack (712), the method ends, as shown in block 795. The MFP begins the scanning process, as shown in block 720. The user specified pattern is applied to the scanned set of documents, as shown in block 722. That is, the total page count number of pages in the pattern is evaluated and the batch split pattern total number of documents is culled from pages. For example, if the total page count is 13 and the batch split pattern total number is 3, 13 pages are evaluated according to the pattern, and a group of 3 documents is identified. The documents have page numbers corresponding to the numbers specified by the user. So, in the example from FIG. 6, a 10 page document, a 1 page document and a 2 page document are identified.

A check is made whether the repeat pattern option is set, as shown in block 724. If the repeat pattern option is not set (724), the scanned document set is saved, as shown in block 750, in a default location, and the flow of actions proceed to block 712. According to the example described in the prior paragraph, batch split pattern total number of 3 documents are saved in a default location, the 3 documents being a 10 page document, a 1 page document and a 2 page document.

If the repeat pattern option is set (724), a check is made to determine whether the create folder option was selected by the user, as shown in block 730. If the create folder option was selected by the user (730), a folder is created in the destination for each group of documents in the pattern, as shown in block 740. In one embodiment, a system default folder name is used which may be for example, a time/date stamp, a sequentially increasing number, etc. In another embodiment, user specification of a portion of the destination folder name may be received and prepended or appended to a time/date stamp, a sequentially increasing number, etc. Further, user specification of the destination location may be received.

After folder creation (740) and when the folder creation option is not selected, the flow of actions continues at block 750 and the scanned set is saved to the destination, which may be user specified or a system default. The destination may be, for example, a hard disk drive (HDD), silicon storage device (SSD) or other similar storage device in the MFP or coupled to the MFP, a network attached storage device, a storage device in a computer, server or other computing device accessible over a network. The flow of actions then returns to block 712.

The actions in the flow chart shown in FIG. 7 continue repeatedly and sequentially until no pages remain to be scanned. According to the example described above, 13 pages are evaluated and three documents having lengths of 10 pages, 1 page and 2 pages are sorted during each iteration, either in a default folder or in groups of 3 in a separate subfolder, depending on the user selection. Depending on the implementation, any remaining pages may be scanned or ignored.

It is claimed:

1. A method for batch separation with a print job comprising:
receiving from a user specification of a pattern in a document set, the pattern specification including a page count for each document in the document set and a document order of the documents in the document set;
sensing pages;
scanning the pages;
applying the pattern specification to the pages to create a group of documents, the group of documents including a plurality of documents separated according to the pattern specification; and
storing the group of documents in a destination location.

2. The method of claim 1 wherein the applying comprises:
evaluating a pattern total number of pages, the pattern total number of pages being the sum of the page counts for each document in the document set; and
identifying a batch split pattern total number of documents within the pattern total number of pages according to the page counts for each of the batch split pattern total number of documents.

3. The method of claim 1 further comprising:
receiving from the user a repeat pattern specification;
repeatedly sequentially performing the scanning, the apply and the storing; and
receiving from the user specification to create a new folder for each document set such that the storing includes storing each of a plurality of groups of documents in a separate subfolder in the destination location.

4. The method of claim 1 further comprising:
receiving from the user a repeat pattern specification; and
repeatedly sequentially performing the sensing, scanning, the applying and the storing until there are no further documents.

5. A multifunction peripheral (MFP) comprising a processor, a memory and a storage medium having instructions thereon which when executed by the processor cause the MFP to perform actions for batch separation comprising:
receiving from a user specification of a pattern in a document set, the pattern specification including a page count for each document in the document set and a document order of the documents in the document set;
sensing pages;
scanning the pages;
applying the pattern specification to the pages to create a group of documents, the group of documents including a plurality of documents separated according to the pattern specification; and
storing the group of documents in a destination location.

6. The MFP of claim 5 wherein the applying comprises:
evaluating a pattern total number of pages, the pattern total number of pages being the sum of the page counts for each document in the document set; and
identifying a batch split pattern total number of documents within the pattern total number of pages according to the page counts for each of the batch split pattern total number of documents.

7. The MFP of claim 5 wherein the storage medium has further instructions stored thereon which when executed cause the MFP to perform further actions for batch separation comprising:
receiving from the user a repeat pattern specification;
repeatedly sequentially performing the scanning, the applying and the storing; and
receiving from the user specification to create a new folder for each document set such that the storing includes storing each of a plurality of groups of documents in a separate subfolder in the destination location.

8. The MFP of claim 5 wherein the storage medium has further instructions stored thereon which when executed cause the MFP to perform further actions for batch separation comprising:
receiving from the user a repeat pattern specification; and
repeatedly sequentially performing the sensing, scanning, the applying and the storing until there are no further documents.

9. A storage medium having instructions thereon which when executed by a processor cause a multifunction peripheral (MFP) to perform actions for batch separation comprising:
receiving from a user specification of a pattern in a document set, the pattern specification including a page count for each document in the document set and a document order of the documents in the document set;
sensing pages;
scanning the pages;
applying the pattern specification to the pages to create a group of documents, the group of documents including a plurality of documents separated according to the pattern specification; and
storing the group of documents in a destination location.

10. The storage medium of claim 5 wherein the applying comprises:
evaluating a pattern total number of pages, the pattern total number of pages being the sum of the page counts for each document in the document set; and
identifying a batch split pattern total number of documents within the pattern total number of pages according to the page counts for each of the batch split pattern total number of documents.

11. The storage medium of claim 5 having further instructions stored thereon which when executed cause the MFP to perform further actions for batch separation comprising:
receiving from the user a repeat pattern specification;
repeatedly sequentially performing the scanning, the applying and the storing; and
receiving from the user specification to create a new folder for each document set such that the storing includes storing each of a plurality of groups of documents in a separate subfolder in the destination location.

12. The storage medium of claim 5 having further instructions stored thereon which when executed cause the MFP to perform further actions for batch separation comprising:
receiving from the user a repeat pattern specification; and
repeatedly sequentially performing the sensing, scanning, the applying and the storing until there are no further documents.
